(19) United States
(12) Patent Application Publication
(10) Pub. No.: US 2009/0192013 A1
(43) Pub. Date: Jul. 30, 2009

(54) Hybrid Vehicle

(75) Inventors: Houng Joong Kim, Mito (JP); Taizo Miyazaki, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Tokyo (JP)

(21) Appl. No.: 12/276,784

(22) Filed: Nov. 24, 2008

(30) Foreign Application Priority Data
Nov. 26, 2007 (JP) 2007-304685

(51) Int. Cl. B60W 10/08; B60W 10/10; B60W 20/00

(52) U.S. Cl. 477/3; 903/930

(57) ABSTRACT

An object of the present invention is to provide a hybrid vehicle having a simple system configuration.

The hybrid vehicle comprises an engine 10; a continuously variable transmission 20 connected to an output shaft of the engine 10; and a rotating electric machine 100 operating as a motor or a generator. The rotating electric machine 100 is the permanent magnet field type having field-generating permanent magnets 124 in a rotor. The rotating electric machine 100 is also the variable flux type having a first rotor 120A and a second rotor 120B rotatably provided on the inner circumference of a stator 110 so that the amount of effective magnetic flux can be varied through means for adjusting the relative phase angle by changing a magnetic pole position by permanent magnets of the second rotor 120B relative to a magnetic pole position by permanent magnets of the first rotor 120A. The hybrid vehicle further comprises a control unit 40 for controlling the speed change ratio of the continuously variable transmission; and an actuator 182 for changing the magnetic pole position of the second rotor in the variable flux type rotating electric machine in interlocking relation with variable control of the speed change ratio of the continuously variable transmission 20 by the control unit 40.

### BACKGROUND OF THE INVENTION

1. Field of the Invention

The present invention relates to a hybrid vehicle which uses an engine and a motor as sources of power, and more particularly to a hybrid vehicle suitably using a variable flux type rotating electric machine as a motor.

2. Description of the Related Art

With conventional permanent-magnet field type rotating electric machines, the amount of effective magnetic flux, i.e., a magnetic flux generated by permanent magnets arranged in a rotor acting on a stator, can be varied by axially pulling out part of the rotor. Such a technique is disclosed, for example, in JP-A-2002-262534. When a permanent magnet field type rotating electric machine is used as a generator, the induced electromotive force of the rotating electric machine proportionally increases with increasing rotational angular velocity ω (number of rotations) thereof. In this case, if the position of a permanent magnet of a second rotor relative to the position of a permanent magnet of a first rotor is changed, the relative phase angle is also changed. This reduces the amount of effective magnetic flux, enabling power generation at high rotational speed.

### SUMMARY OF THE INVENTION

When a conventional variable flux type rotating electric machines is used as a generator, in order to vary the amount of effective magnetic flux in relation to the number of rotations, a control system for axially moving part of a rotor is required.

With a conventional hybrid vehicle on the other hand, an engine control system, a transmission control system, etc. are required resulting in a problem that the system configuration becomes complicated.

An object of the present invention is to provide a hybrid vehicle having a simple system configuration.

(1) In order to attain the above-mentioned object, the present invention provides a hybrid vehicle comprising: an engine; a rotating electric machine operating as a motor or a generator; and a continuously variable transmission connected to an output shaft of the engine; wherein the rotating electric machine is the permanent magnet field type having field-generating permanent magnets on a rotor, and also the variable flux type having first and second rotors rotatably provided on the inner circumference of a stator so that the amount of effective magnetic flux can be varied through means for adjusting the relative phase angle by changing a magnetic pole position by permanent magnets of the second rotor relative to a magnetic pole position by permanent magnets of the first rotor; the hybrid vehicle further comprising means for controlling the speed change ratio of the continuously variable transmission; and interlocking means for changing the magnetic pole position of the second rotor in the variable flux type rotating electric machine in interlocking relation with variable control of the speed change ratio of the continuously variable transmission by the control means.

This configuration simplifies the system configuration.

(2) The hybrid vehicle according to (1), wherein the actuator of the continuously variable transmission is preferably a hydraulic transmission actuator controlled by the control means; and wherein the interlocking means is a hydraulic actuator for phase angle adjustment which drives the relative phase angle adjustment means of the rotating electric machine and is driven by the hydraulic pressure supplied to the hydraulic transmission actuator.

(3) The hybrid vehicle according to (1), wherein the actuator of the continuously variable transmission is preferably a transmission actuator controlled by the control means; and wherein the interlocking means is a link mechanism which drives the relative phase angle adjustment means of the rotating electric machine and transmits the variation of the center distance of a pulley of the continuously variable transmission driven by the transmission actuator.

(4) The hybrid vehicle according to (1), wherein the rotating electric machine is preferably connected to the output shaft side of the continuously variable transmission.

(5) The hybrid vehicle according to (1), wherein the rotating electric machine is preferably connected to the input shaft side of the continuously variable transmission.

(6) The hybrid vehicle according to (1), wherein the relative phase angle adjustment means is preferably composed of a differential mechanism.

(7) The hybrid vehicle according to (1), wherein the relative phase angle adjustment means is preferably configured such that the first rotor is fixed to a shaft, the second rotor is separated from the shaft, and the shaft and the second rotor can be displaced within an angular range for a single magnetic pole.

### BRIEF DESCRIPTION OF THE DRAWINGS

FIG. 1 is a schematic view showing the general configuration of a hybrid vehicle according to a first embodiment of the present invention.

FIG. 2 is an elevational view showing the configuration of a rack mechanism used for the hybrid vehicle according to the first embodiment of the present invention.

FIG. 3 is a perspective view showing the configuration of a rotating electric machine used for the hybrid vehicle according to the first embodiment of the present invention.

FIGS. 4A to 4D are elevational views showing the configuration of a first differential mechanism used for the rotating electric machine of the hybrid vehicle according to the first embodiment of the present invention.

FIGS. 5A and 5B are lever analogy diagrams showing the operation of first and second differential mechanisms used for the rotating electric machine of the hybrid vehicle according to the first embodiment of the present invention.

FIG. 6 is a fragmentary side view of a spatial cam mechanism used for the rotating electric machine of the hybrid vehicle according to the first embodiment of the present invention.

FIGS. 7A and 7B are elevational views of a spatial cam mechanism used for the rotating electric machine of the hybrid vehicle according to the first embodiment of the present invention.

FIGS. 8A and 8B are diagrams showing the operation of the spatial cam mechanism used for the rotating electric machine of the hybrid vehicle according to the first embodiment of the present invention.

FIGS. 9A to 9D are diagrams showing control of a continuously variable transmission and the rotating electric machine in the hybrid vehicle according to the first embodiment of the present invention.

FIG. 10 is a perspective view showing a second configuration of the rotating electric machine used for the hybrid vehicle according to the first embodiment of the present invention.

FIGS. 11A and 11B are lever analogy diagrams showing the operation of first and second differential mechanisms used for the rotating electric machine of the hybrid vehicle according to the first embodiment of the present invention.

FIG. 12 is a side view showing a third configuration of the rotating electric machine used for the hybrid vehicle according to the first embodiment of the present invention.

FIG. 13 is an elevational view showing the third configuration of the hybrid vehicle according to the first embodiment of the present invention.

FIG. 14 is a schematic view showing the general configuration of a hybrid vehicle according to a second embodiment of the present invention.

FIG. 15 is a diagram showing the operation of an interlock mechanism in the hybrid vehicle according to the second embodiment of the present invention of operation.

FIG. 16 is a schematic view showing the general configuration of a hybrid vehicle according to a third embodiment of the present invention.

FIGS. 17A to 17D are diagrams showing control of a continuously variable transmission and the rotating electric machine in the hybrid vehicle according to the second embodiment of the present invention.

### DESCRIPTION OF THE PREFERRED EMBODIMENTS

The configuration and operation of a hybrid vehicle according to a first embodiment of the present invention will be explained below with reference to FIGS. 1 to 13.

First, the general configuration of the hybrid vehicle according to the present embodiment will be explained below with reference to FIG. 1.

FIG. 1 is a schematic view showing the general configuration of the hybrid vehicle according to the first embodiment of the present invention.

An output shaft of an engine 10 is connected to a continuously variable transmission 20. The continuously variable transmission 20 includes a primary pulley 22, a secondary pulley 24, a metal belt 26, and a hydraulic actuator 28. The shaft of the primary pulley 22 is connected with the output shaft of the engine 10. The primary pulley 22 and the secondary pulley 24 are linked with each other through the metal belt 26. The shaft of the secondary pulley 24 is connected with the shaft of a rotating electric machine 100. The hydraulic actuator 28 is operated by the hydraulic pressure supplied from a pump 30. When the hydraulic pressure is high, the hydraulic actuator 28 increases the force of pressing onto the primary pulley 22 to increase the center distance of the primary pulley 22 and decrease the radius of the primary pulley 22 at which the belt 26 is in contact with the primary pulley 22. As a result, the speed change ratio in the continuously variable transmission 20 decreases. In contrast, when the hydraulic pressure becomes low, the hydraulic actuator 28 decrease the force of pressing onto the primary pulley 22 to decrease the center distance of the primary pulley 22 and increase the pulley radius. As a result, the speed change ratio in the continuously variable transmission 20 increases.

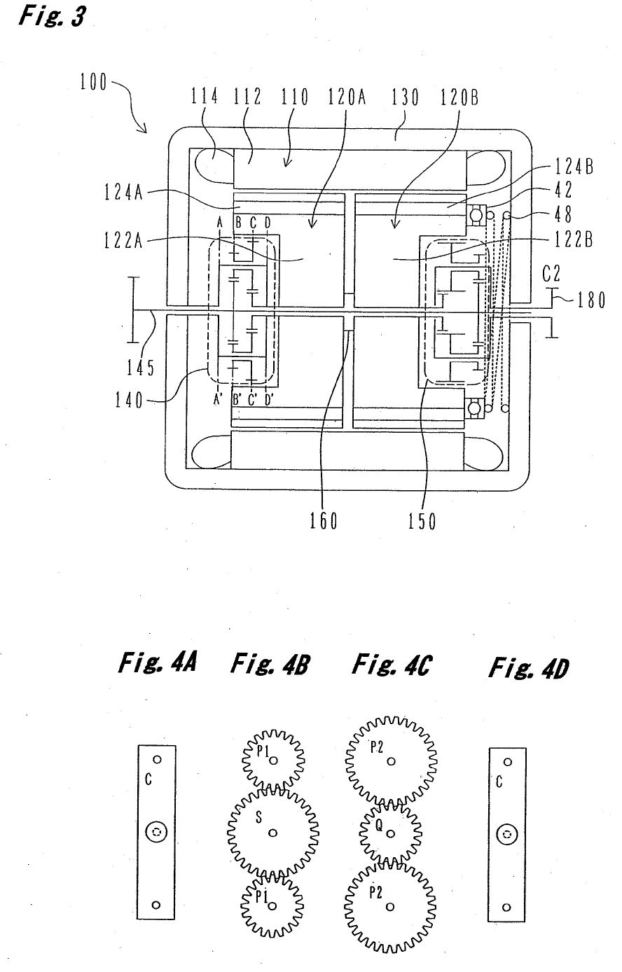

The rotating electric machine 100 is a permanent magnet field type rotating electric machine and also a variable flux type rotating electric machine that can vary the amount of effective magnetic flux, i.e., a magnetic flux generated by permanent magnets arranged in a rotor acting on a stator. The rotating electric machine 100 comprises first and second rotors. The second rotor can be axially reciprocated while rotating around the shaft of the rotating electric machine 100. When the second rotor rotates relative to the first rotor, the position of permanent magnets of the second rotor relative to the position of permanent magnets of the first rotor can be changed to produce a relative phase angle. The configuration of the rotating electric machine 100 will be mentioned in detail later with reference to FIG. 3.

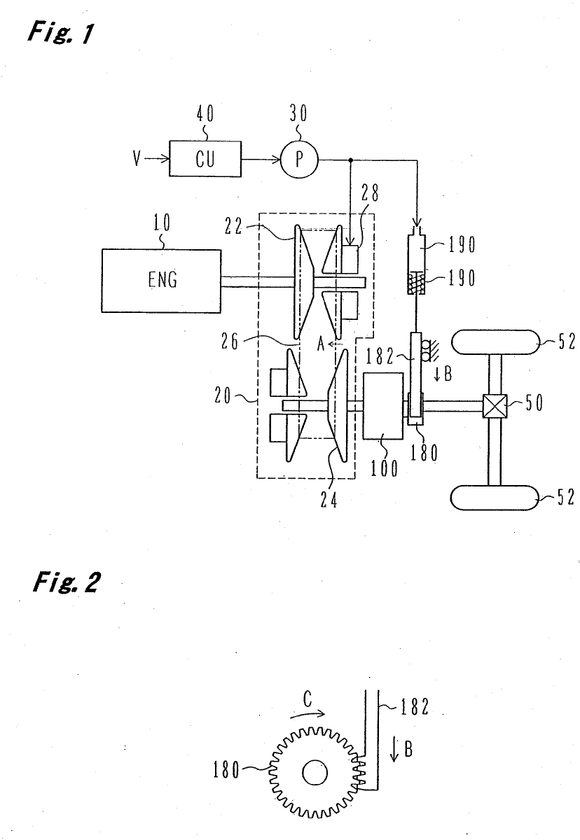

The rotating electric machine 100 further comprises a mechanical relative phase input shaft 180. A rack mechanism 182 is engaged with the mechanical relative phase input shaft 180. As mentioned later with reference to FIG. 2, a pinion gear is formed on the outer circumference of the mechanical relative phase input shaft 180, and the rack mechanism 182 is engaged with this pinion gear. The rack mechanism 182 is driven by a hydraulic actuator 190. The hydraulic pressure is supplied from the pump 30 to the hydraulic actuator 190. The hydraulic actuator 190 is provided with a return spring 192 for returning the rack mechanism 182 when the hydraulic pressure decreases.

A control unit 40 controls the speed change ratio of the continuously variable transmission 20 and at the same time variably controls the amount of effective magnetic flux in the rotating electric machine 100. Specifically, the control unit 40 variably controls the amount of effective magnetic flux in the rotating electric machine 100 in interlocking relation with control of the speed change ratio of the continuously variable transmission 20.

The control unit 40 controls the hydraulic pressure of the pump 30 in response to the vehicle speed; specifically, the control unit 40 decreases the hydraulic pressure of the pump 30 as the vehicle speed increases. At this time, the hydraulic actuator 28 is actuated to move the primary pulley 22 of the continuously variable transmission 20 in the direction shown by an arrow A, thus decreasing the center distance of the primary pulley 22 resulting in reduction of the speed change ratio. At the same time, the hydraulic actuator 190 is actuated to move the rack mechanism 182 in the direction shown by an arrow B. Then, the mechanical relative phase input shaft 180 is rotated to rotate the second rotor relative to the first rotor of the rotating electric machine 100, thus decreasing the amount of effective magnetic flux in the rotating electric machine 100. Accordingly, the continuously variable transmission 20 and the amount of effective magnetic flux in the rotating electric machine 100 can be controlled using a single control unit 40 making it possible to simplify the system configuration of the control unit. Control by the control unit 40 will be mentioned in detail later with reference to FIG. 9.

The driving force of the engine 10 is transmitted to wheels 52 through the continuously variable transmission 20 and a differential gear 50. Further, the driving force generated when the rotating electric machine 100 operates as a motor is transmitted to the engine 10 through the continuously variable transmission 20 to start the engine 10. Further, the driving force generated when the rotating electric machine 100 operates as a motor can also be transmitted to the wheels 52 through the differential gear 50. When the rotating electric machine 100 operates as a generator, the rotating electric machine 100 is driven by the driving force of the wheels 52 to operate as a generator.

The configuration of the rack mechanism 182 used for the hybrid vehicle according to the present embodiment will be explained below with reference to FIG. 2.

FIG. 2 is an elevational view showing the configuration of the rack mechanism used for the hybrid vehicle according to the first embodiment of the present invention. The same reference numerals as in FIG. 1 denote the same parts.

A pinion gear is formed on the outer circumference of the mechanical relative phase input shaft 180 of the rotating electric machine 100. The rack mechanism 182 is engaged with this pinion gear. When the rack mechanism 182 moves in the direction shown by an arrow B, the mechanical relative phase input shaft 180 rotates in the direction shown by an arrow C.

A first configuration of the rotating electric machine 100 used for the hybrid vehicle according to the present embodiment will be explained below with reference to FIGS. 3 to 8.

First, the general configuration of the rotating electric machine 100 used for the hybrid vehicle according to the present embodiment will be explained below with reference to FIG. 3.

FIG. 3 is a perspective view showing the configuration of the rotating electric machine used for the hybrid vehicle according to the first embodiment of the present invention. The same reference numerals as in FIG. 1 denote the same parts.

The rotating electric machine 100 comprises a stator 110, a first rotor 120A, and a second rotor 120B. The stator 110 is composed of the stator iron core 112 and the stator coils (armature windings) 114 wound around the stator iron core 112. The stator 110 is fixedly supported on the inner circumference side of a housing 130.

The first rotor 120A and the second rotor 120B are rotatably disposed on the inner circumference side of the stator 110 through a gap. The first rotor 120A is composed of a rotor iron core 122A and permanent magnets 124A embedded in the rotor iron core 122A. The second rotor 120B is composed of a rotor iron core 122B and permanent magnets 124B embedded in the rotor iron core 122B. When four permanent magnets 124A and four permanent magnets 124B are provided, a 4-pole permanent magnet field type rotating electric machine is configured. The permanent magnets 124A and 124B may be surface magnets attached on the surface of the rotor iron cores 122A and 122B.

The second rotor 120B can be rotated relative to the first rotor 120B by rotating the mechanical relative phase input shaft 180. When each of the first rotor 120A and the second rotor 120B has four poles, a state where the circumferential position of a first permanent magnet of the first rotor 120A coincides with that of a first permanent magnet of the second rotor 120B, having the same polarity as the first permanent magnet of the first rotor 120A, is referred to as reference angle (0 degree). In this state, the first permanent magnet of the second rotor 120B can be rotated relative to the first permanent magnet of the first rotor 120A within a mechanical angular range of 45 degrees (an electrical angle of 90 degrees).

Therefore, the present embodiment includes a first differential mechanism 140, a second differential mechanism 150, a spatial cam mechanism 160, and the mechanical relative phase input shaft 180. The first differential mechanism 140 is attached to the first rotor 120A. The first differential mechanism 140 will be mentioned later with reference to FIG. 4. The second differential mechanism 150 is attached to the second rotor 120B. The mechanical relative phase input shaft 180 mentioned earlier is an input shaft for changing the relative mechanical angle formed with respect to the first rotor 120A by the second rotor 120B. When the mechanical relative phase input shaft 180 is rotated, the relative mechanical angle of the first rotor 120 with respect to the second rotor 120B can be changed; as a result, the relative phase angle of the first rotor 120A with respect to the second rotor 120B can be changed. The spatial cam mechanism 160 is provided so as to increase the center distance between the first rotor 120A and the second rotor 120B in proportion to the increase in the relative mechanical angle by the rotation of the mechanical relative phase input shaft 180. The spatial cam mechanism 150 will be explained below with reference to FIGS. 6 to 8.

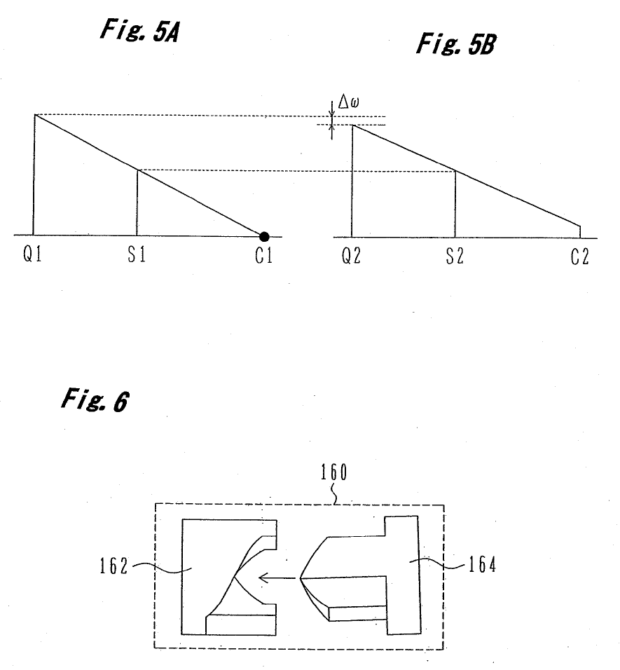

The configuration of the first differential mechanism 140 used for the rotating electric machine 100 of the hybrid vehicle according to the present embodiment will be explained below with reference to FIGS. 4 and 5.

FIG. 4 is an elevational view showing the configuration of the first differential mechanism used for the rotating electric machine of the hybrid vehicle according to the first embodiment of the present invention. FIG. 5 is a lever analogy diagram showing the operation of the first and second differential mechanisms used for the rotating electric machine of the hybrid vehicle according to the first embodiment of the present invention.

Referring to FIG. 4, FIG. 4A shows a cross-section along the line A-A′ of FIG. 3, FIG. 4B a cross-section along the line B-B′ of FIG. 3, FIG. 4C a cross-section along the line C-C′ of FIG. 3, and FIG. 4D a cross-section along the line D-D′ of FIG. 3.

FIGS. 4A and 4D denote a carrier of the differential mechanism 140. FIG. 4B shows a sun gear S and orbital gears P1 engaged with the sun gear S to move around the sun gear S. FIG. 4C shows a sun gear Q having different number of teeth from the sun gear S and orbital gears P2 engaged with the sun gear Q to move around the sun gear Q. The orbital gears P1 and P2 are restrained by carriers C so that the rotational speed and orbital speed of the orbital gears P1 coincide with those of the orbital gears P2, thereby attaining a differential mechanism.

The carrier of the first differential mechanism 140 is fixed to the housing 130. Further, the first differential mechanism 140 and the second differential mechanism 150 have the same number of teeth. The mechanical relative phase input shaft 180 is attached to the carrier of the second differential mechanism 150. The first rotor 120A is attached to the sun gear Q of the first differential mechanism 140. The second rotor 120B is attached to the sun gear Q of the second differential mechanism 150. The sun gear S of the first differential mechanism 140 and the sun gear S of the second differential mechanism 150 are rigidly connected to the same single shaft, i.e., a mechanical output shaft 145 of the rotating electric machine 100.

With the above configuration, when the mechanical relative phase input shaft 180 is fixed, each machine element of the first differential mechanism 140 and the second differential mechanism 150 moves exactly in the same way. Further, when a rotational input is given to the mechanical relative phase input shaft 180, the angular velocity of the second differential mechanism 150 changes.

FIG. 5 shows a lever analogy diagram when a rotational input is given to the mechanical relative phase input shaft 180. The lever analogy diagram is used to represent the rotational speed of each revolving shaft of a differential mechanism such as a planetary gear. In FIGS. 5A and 5B, the vertical length means the rotational speed, i.e., a longer vertical length means higher speed. Further, with a differential mechanism, rotational speeds represented by the Q, S, and C axes are arranged on a straight line.

FIG. 5A is a lever analogy diagram of the first differential mechanism 140, and FIG. 5B is a lever analogy diagram of the second differential mechanism 150. In order to input a relative phase angle of Δω to the first rotor 120A and the second rotor 120B, an angular velocity is given to the mechanical relative phase input shaft 180 and then the shaft is fixed.

The configuration of a spatial cam mechanism 160 used for the rotating electric machine 100 of the hybrid vehicle according to the present embodiment will be explained below with reference to FIGS. 6 to 8.

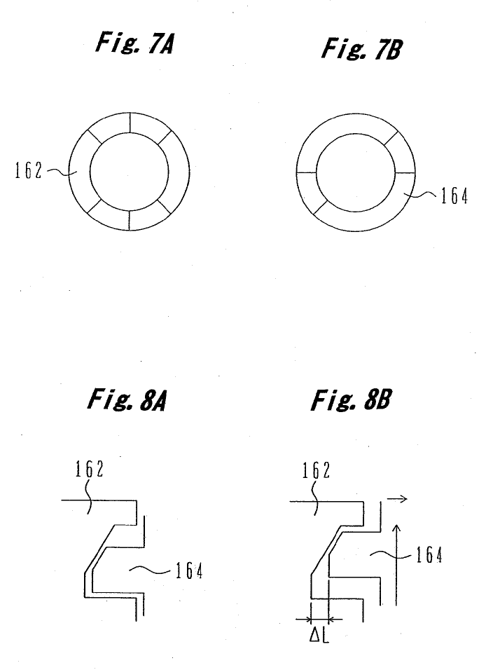

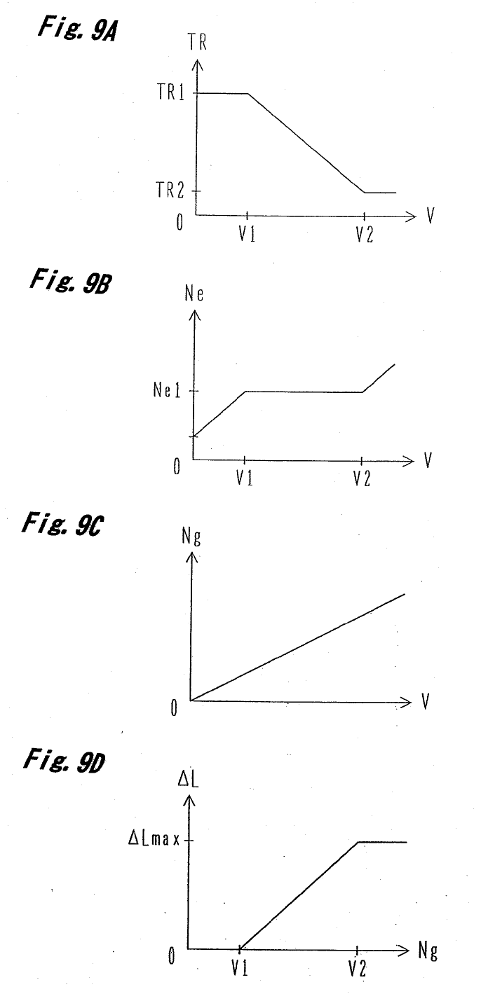

FIG. 6 is a fragmentary side view of the spatial cam mechanism used for the rotating electric machine of the hybrid vehicle according to the first embodiment of the present invention. FIG. 7 is an elevational view of the spatial cam mechanism used for the rotating electric machine of the hybrid vehicle according to the first embodiment of the present invention. FIG. 8 is a diagram showing the operation of the spatial cam mechanism used for the rotating electric machine of the hybrid vehicle according to the first embodiment of the present invention.

As shown in FIG. 6, the spatial cam mechanism 160 is composed of a first cam 162 fixed to the first rotor 120A and a second cam 164 fixed to the second rotor 120B. The cam surface profile of the first cam 162 is shown in FIGS. 6 and 7(A). The cam surface profile of the second cam 164 is shown in FIGS. 6 and 7B.

FIG. 8 explains the operation of the first cam 162 and the second cam 164. When a relative phase angle is given to the second rotor 120B, the second cam 164 is rotatably changed, and the axial distance between the first cam 162 and the second cam 164 increases. Accordingly, the second rotor 120B moves in the direction of an arrow F (the axial direction of the rotating electric machine 100) by an axial distance ΔL and then is pushed out.

Control of the continuously variable transmission and the rotating electric machine in the hybrid vehicle according to the present embodiment will be explained below with reference to FIG. 9.

FIG. 9 is a diagram showing control of the continuously variable transmission and the rotating electric machine in the hybrid vehicle according to the first embodiment of the present invention.

FIG. 9A shows a basic relation between the vehicle speed V and the speed change ratio TR of the continuously variable transmission 20. FIG. 9B shows a relation between the vehicle speed V and the number of rotations Ne of the engine 10 when the speed change ratio TR is changed as shown in FIG. 9A. FIG. 9C shows a relation between the vehicle speed V and the number of rotations Ng of the rotating electric machine operating as a generator when the speed change ratio TR is changed as shown in FIG. 9A. FIG. 9D shows a relation between the number of rotations Ng of the rotating electric machine and the axial distance ΔL when the second rotor is axially pushed out by the spatial cam 160 explained in FIGS. 6 to 8.

As shown in FIG. 9A, the continuously variable transmission 20 can continuously change the speed gear ratio within a range from a large speed change ratio TR1 to a small speed change ratio TR2. The speed change ratio TR1 is, for example, about 2.4, and the speed change ratio TR2 is, for example, about 0.6.

As shown in FIG. 9A, the speed change ratio TR of the continuously variable transmission is maintained to the large speed change ratio TR1 until the vehicle speed reaches a predetermined vehicle speed V1 from 0 km/h. In the meantime, as shown in FIG. 9B, the number of rotations Ne of the engine gradually increases and then reaches Ne1 when the vehicle speed is V1. The number of rotations Ne1 of the engine is, for example, 2000 rpm.

As shown in FIG. 9A, within a range between the vehicle speeds V1 and V2, the speed change ratio TR of the continuously variable transmission is continuously changed within a range from the large speed change ratio TR2 to the small speed change ratio TR2. In the meantime, as shown in FIG. 9B, the number of rotations Ne of the engine is maintained to the number of rotations Ne1.

As shown in FIG. 9A, when the vehicle speed exceeds the vehicle speed V2, the speed change ratio TR of the continuously variable transmission is maintained to the small speed change ratio TR2. In the meantime, as shown in FIG. 9B, the number of rotations Ne of the engine gradually increases from the number of rotations Ne1.

The above-mentioned control of the speed change ratio TR of the continuously variable transmission denotes basic control, and speed change control differs in relation to the accelerator opening indicating driver's intention and a load indicating the engine state. For example, when the vehicle is started up, if the accelerator opening is large and sudden acceleration is requested as driver's intention, the large speed change ratio TR1 is maintained for up to a vehicle speed faster than the vehicle speed V1, that is, the speed change ratio for the low-speed region is maintained for up to a higher vehicle speed, enabling sudden acceleration.

On the other hand, as shown in FIG. 1, the rotating electric machine 100 is connected to the wheels 52 through a differential gear 50. Therefore, as shown in FIG. 9C, the number of rotations Ng of the rotating electric machine 100 increases in proportion to the vehicle speed V.

Further, since the axial distance ΔL of the second rotor 120B in the rotating electric machine 100 changes in interlocking relation with control of the speed change ratio TR shown in FIG. 9A, the axial distance ΔL changes as shown in FIG. 9D. Specifically, the axial distance ΔL is maintained to zero until the vehicle speed V1 is reached and, in a range between the vehicle speeds V1 and V2, increases up to ΔLmax with increasing vehicle speed V. Further, when the vehicle speed V2 is exceeded, the axial distance ΔL is maintained to ΔLmax.

As mentioned above, the relative phase difference of the second rotor 120B from the first rotor 120A is the reference angle (0 degree) when the axial distance ΔL is 0. The rotating electric machine is designed such that, when the axial distance ΔL is ΔLmax, the relative phase difference of the second rotor 120B from the first rotor 120A becomes a mechanical angle of 45 degrees (an electrical angle of 90 degrees).

Therefore, the relative phase difference of the second rotor 120B from the first rotor 120A changes with the number of rotations Ng of the rotating electric machine 100 in the same way as in FIG. 9D.

With the permanent magnet field type rotating electric machine 100 used as a generator, when the rotational angular velocity ω (number of rotations) of the rotating electric machine increases, the induced electromotive force of the rotating electric machine proportionally increases. In this case, with the rotating electric machine of the present embodiment, the position of the permanent magnets of the second rotor relative to the permanent magnets of the first rotor is changed to change the relative phase angle and accordingly reduce the amount of effective magnetic flux, thus enabling power generation at high rotational speed.

Assume a case where the control unit 40 controls the relative phase difference of the second rotor 120B from the first rotor 120A of the rotating electric machine 100 in interlocking relation with control of the speed change ratio of the continuously variable transmission 20, like the present embodiment. As shown in FIG. 9D, when the vehicle speed increases within a range between the vehicle speeds V1 and V2, the relative phase difference can be increased allowing control so as to decrease the amount of effective magnetic flux, thus enabling power generation at high rotational speed. Therefore, the speed change ratio of the continuously variable transmission 20 and the amount of effective magnetic flux of the variable flux type rotating electric machine 100 can be controlled using a single control unit.

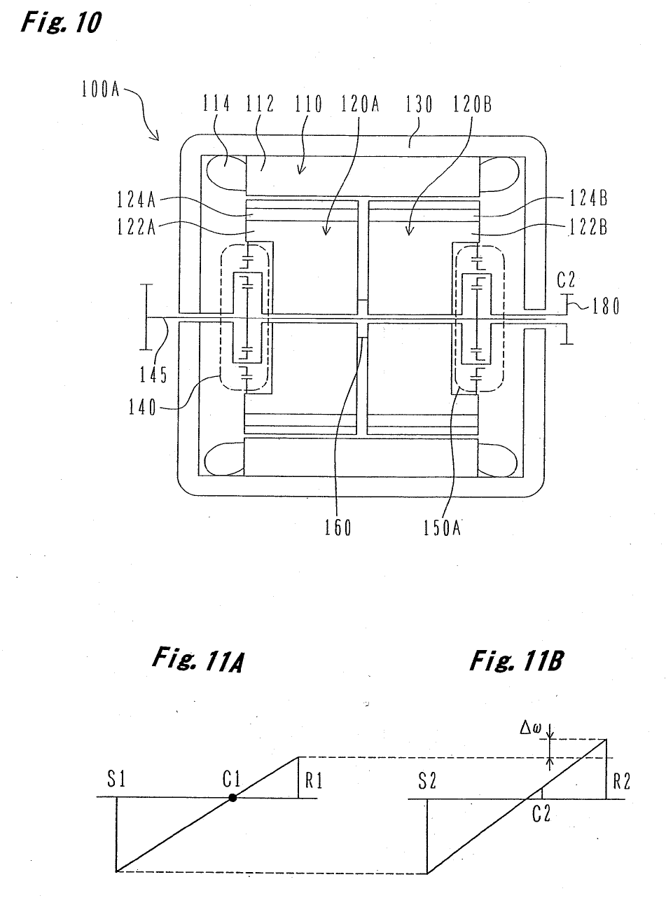

A second configuration of the rotating electric machine used for the hybrid vehicle according to the present embodiment will be explained below with reference to FIGS. 10 and 11.

FIG. 10 is a perspective view showing the second configuration of the rotating electric machine used for the hybrid vehicle according to the first embodiment of the present invention. FIG. 11 is a lever analogy diagram showing the operation of the first and second differential mechanisms used for the rotating electric machine of the second configuration of the hybrid vehicle according to the first embodiment of the present invention. The same reference numerals as in FIG. 3 denote the same parts.

A rotating electric machine 100A of the present embodiment differs from the rotating electric machine 100 of FIG. 3 in the configuration of a first differential mechanism 140A and a second differential mechanism 150A. Other elements are the same as those shown in FIG. 3.

The first differential mechanism 140A and the second differential mechanism 150A use common planetary gears. Further, the planetary gears of the first differential mechanism 140A and the counterparts of the second differential mechanism 150A have the same number of teeth. Also in the present embodiment, a carrier of the first differential mechanism 140A is fixed to the housing 130, and a carrier of the second differential mechanism 150A is connected to the mechanical relative phase input shaft 180.

Referring to the lever analogy diagram of FIG. 11, FIG. 11A is a lever analogy diagram of the first differential mechanism 140A, and FIG. 11B a lever analogy diagram of the second differential mechanism 150A. From these, the relative phase angle can be input like FIG. 3.

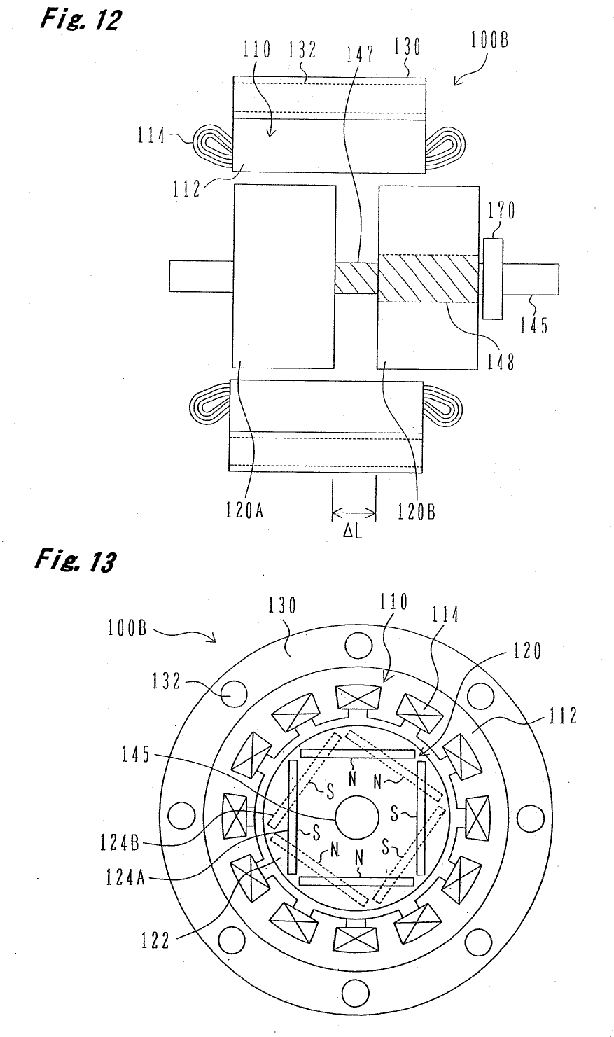

A third configuration of the rotating electric machine used for the hybrid vehicle according to the present embodiment will be explained below with reference to FIGS. 12 and 13.

FIG. 12 is a side view showing the third configuration of the rotating electric machine used for the hybrid vehicle according to the first embodiment of the present invention. FIG. 13 is an elevational view showing the third configuration of the hybrid vehicle according to the first embodiment of the present invention. The same reference numerals as in FIG. 3 denote the same parts. Further, the configuration of the rotating electric machine shown in FIGS. 12 and 13 is the same as that shown in FIG. 1 of JP-A-2002-262534, an invention previously applied by the inventors of the present application and disclosed.

The stator iron core 112 of the stator 110, where armature windings 114 are wound in slots, is shrink-fitted into or press-fitted into the housing 130. Cooling-water channels 132 where cooling water flows are formed in the housing 130.

The rotors 120 having embedded permanent magnets are composed of the first rotor 120A fixed to the shaft 145 and the second rotor 120B separated from the shaft 145.

The first rotor 120A is provided with four permanent magnets 124A such that different polarities are sequentially arranged in the rotational direction. Likewise, the second rotor 120B is provided with four permanent magnets 124B such that different polarities are sequentially arranged in the rotational direction. The field-generating magnets composed of the first and second rotors disposed on the same shaft face to the magnetic pole of the stator.

A male thread portion 147 is formed on the outer circumference of a position of the shaft 145 where the second rotor 120B is disposed. Further, a female thread portion 148 is formed on the inner circumference of the second rotor 120B. The male thread portion 147 serves as a screw thread and the female thread portion 148 serves as a nut so that they are connected with each other by the screw function. Therefore, the second rotor 120B can axially move relative to the shaft 145 by an axial distance ΔL while rotating.

Further, a stopper 170 is provided on a side surface of the second rotor 120B to prevent the second rotor 120B from being displaced from the center of the stator by a predetermined distance ΔLmax or more. The position of the stopper 170 can be controlled by the hydraulic actuator 190 shown in FIG. 1. The actuator 190 axially changes the position of the stopper 170 in parallel with the shaft 145 making it possible to change the degree of misalignment between the magnetic pole center of the permanent magnets 124A of the first rotor and that of the permanent magnets 124B of the second rotor. In a state shown in FIG. 13, the magnetic pole center of the permanent magnets 124B of the second rotor is displaced relative to that of the permanent magnets 124A of the first rotor by a mechanical angle of 45 degrees (an electrical angle of 90 degrees). This makes it possible to control the amount of effective magnetic flux of the whole magnets composed of the first and second field-generating magnets with respect to the stator.

The following describes a fact that the above configuration can vary the amount of effective magnetic flux of permanent magnets in relation to the torque direction.

Basically in a rotating electric machine using armature windings for a stator and permanent magnets for a rotor, when the rotational direction of the rotor when the rotating electric machine serves as a motor is the same as the rotational direction of the rotor when it serves as a generator, the direction of torque exerted to the rotor when the rotating electric machine serves as a motor is opposite to the direction of torque exerted to the rotor when it serves as a generator.

Further, when the rotating electric machine serves as a motor, when the rotational direction of the rotor is inverted, the torque direction is also inverted. Likewise, when the rotating electric machine serves as a generator, when the rotational direction of the rotor is inverted, the torque direction is also inverted.

The above-mentioned basic theory of the rotational direction and torque direction is applied to the rotating electric machine according to the present embodiment of the present invention, as explained below.

When the rotating electric machine serves as a motor in the low rotational region, for example, when the engine is started up, the centers of the same magnetic poles of the first rotor 120A and the second rotor 120B are aligned with each other so as to maximize the amount of effective magnetic flux by the permanent magnets facing the magnetic pole of the stator, thus obtaining high torque characteristics.

With the same rotational direction of the rotors as shown in FIG. 13, the direction of torque exerted to the rotors when the rotating electric machine serves as a generator is opposite to the direction of torque exerted to the rotors when it serves as a motor. As the second rotor 120B moves relative to the shaft 145 as if the nut is loosened from the screw thread, the gap between the first rotor 120A and the second rotor 120B increases making the centers of the same magnetic poles of the two rotors misaligned with each other, resulting in a reduced amount of effective magnetic flux by the permanent magnets facing the magnetic pole of the stator. In other words, this configuration provides an effect of field weakening, allowing high power generation characteristics to be obtained in the high rotational region.

The configuration shown in FIGS. 8 to 18 of JP-A-2002-262534 mentioned above can be used also for the variable flux type rotating electric machine.

As mentioned above, with the present embodiment, the control unit controls the relative phase difference of the second rotor from the first rotor of the rotating electric machine in interlocking relation with control of the speed change ratio of the continuously variable transmission. Therefore, the speed change ratio of the continuously variable transmission and the amount of effective magnetic flux of the variable flux type rotating electric machine can be controlled using a single control unit. Therefore, the control system configuration can be simplified.

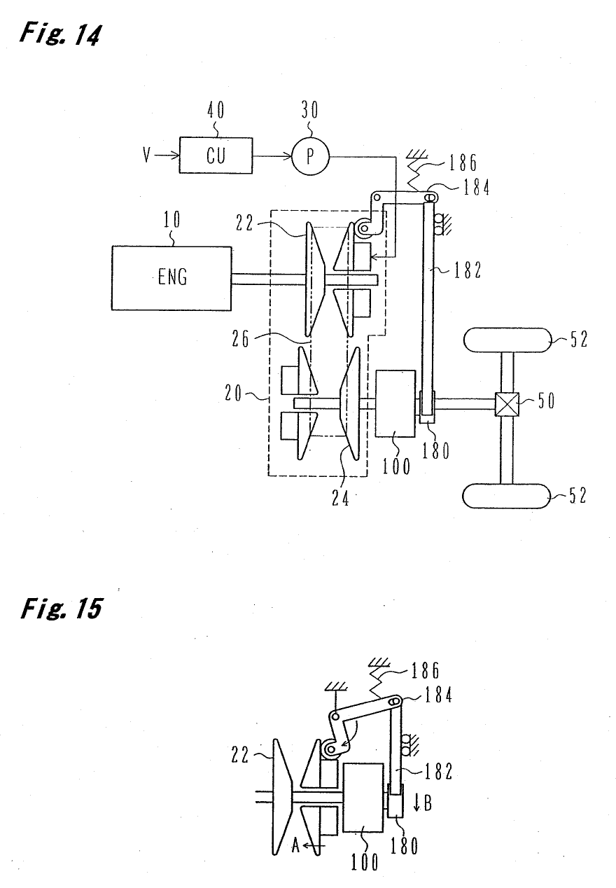

The configuration and operation of a hybrid vehicle according to a second embodiment of the present invention will be explained below with reference to FIGS. 14 and 15.

FIG. 14 is a schematic view showing the general configuration of the hybrid vehicle according to the second embodiment of the present invention. FIG. 15 is a diagram showing the operation of an interlock mechanism in the hybrid vehicle according to the second embodiment of the present invention of operation.

The same reference numerals as in FIG. 1 denote the same parts.

Although the embodiment shown in FIG. 1 performs control of the speed change ratio of the continuously variable transmission in interlocking relation with control of the amount of effective magnetic flux of the rotating electric machine through the use of hydraulic pressure, the present embodiment performs the control operations in mechanical interlocking manner.

Therefore, as shown in FIG. 14, the present embodiment is provided with a link mechanism 184 where one end thereof is in contact with the primary pulley 22 of the continuously variable transmission 20 and the other end thereof is engaged with the rack mechanism 182. The link mechanism 184 is provided with a return spring 186. Other elements are the same as those shown in FIG. 1. The rotating electric machine 100 is composed of the same elements as those shown in FIGS. 3, 10, and 12, etc.

The operation of the present embodiment will be explained below with reference to FIG. 15. One end of the link mechanism 184 is in contact with the primary pulley 22 of the continuously variable transmission 20. When the primary pulley 22 moves in the direction shown by an arrow A for speed change, the link mechanism 184 rotates in the direction shown by an arrow C and accordingly the rack mechanism 182 moves in the direction shown by an arrow B. Then, the mechanical relative phase input shaft 180 rotates to produce a relative phase angle between the first rotor 120A and the second rotor 120B of the rotating electric machine 100. After completion of speed change operation, the width of the primary pulley 22 is fixed and therefore the produced relative phase angle is fixed as it is. As the gap of the primary pulley 22 increases, the mechanical relative phase input shaft 180 is returned to a reference position by the spring 186, and the relative phase angle is returned to the reference angle.

Since the present embodiment also controls the relative phase difference of the second rotor from the first rotor of rotating electric machine in interlocking relation with control of the speed change ratio of the continuously variable transmission, the speed change ratio of the continuously variable transmission and the amount of effective magnetic flux of the variable flux type rotating electric machine can be controlled using a single control unit. Therefore, the control system configuration can be simplified.

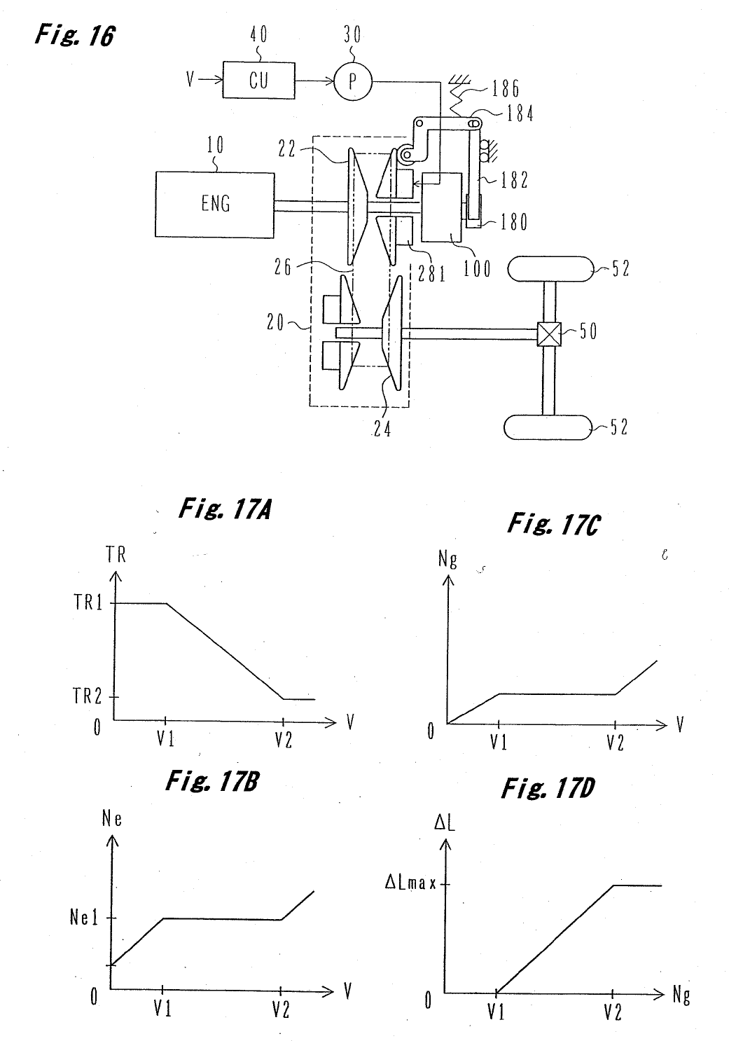

The configuration and operation of a hybrid vehicle according to a third embodiment of the present invention will be explained below with reference to FIGS. 16 and 17.

FIG. 16 is a schematic view showing the general configuration of the hybrid vehicle according to the third embodiment of the present invention. FIG. 17 is a diagram showing control of a continuously variable transmission and the rotating electric machine in the hybrid vehicle according to the second embodiment of the present invention. The same reference numerals as in FIG. 1 denote the same parts.

As shown in FIG. 16, the present embodiment performs control of the speed change ratio of the continuously variable transmission in mechanical interlocking with control of the amount of effective magnetic flux of the rotating electric machine, like FIG. 14. On the other hand, the present embodiment differs from the embodiment of FIG. 14 in the arrangement of the rotating electric machine 100. Specifically, although the embodiment shown in FIG. 1 connects the rotating electric machine 100 to the output shaft side of the continuously variable transmission 20, the present embodiment connects it to the input shaft side of the continuously variable transmission 20, i.e., the engine 10.

Control of the continuously variable transmission and the rotating electric machine in the hybrid vehicle according to the present embodiment will be explained below with reference to FIG. 17.

FIG. 17A shows a basic relation between the vehicle speed V and the speed change ratio TR of the continuously variable transmission 20. FIG. 17B shows a relation between the vehicle speed V and the number of rotations Ne of the engine 10 when the speed change ratio TR is changed as shown in FIG. 17A. FIG. 17C shows a relation between the vehicle speed V and the number of rotations Ng of the rotating electric machine operating as a generator when the speed change ratio TR is changed as shown in FIG. 17A. FIG. 17D shows a relation between the number of rotations Ng of the rotating electric machine and an axial distance ΔL when the second rotor is axially pushed out by the spatial cam 160 explained in FIGS. 6 to 8.

As shown in FIG. 17A, the continuously variable transmission 20 can continuously change the speed gear ratio within a range from the large speed change ratio TR1 to the small speed change ratio TR2. The speed change ratio TR1 is, for example, about 2.4, and the speed change ratio TR2 is, for example, about 0.6.

As shown in FIG. 17A, the speed change ratio TR of the continuously variable transmission is maintained to the large speed change ratio TR2 until the vehicle speed reaches a predetermined vehicle speed V1 from 0 km/h. In the meantime, as shown in FIG. 17B, the number of rotations Ne of the engine gradually increases and then reaches Ne1 when the vehicle speed is V1. The number of rotations Ne1 of the engine is, for example, 2000 rpm.

As shown in FIG. 17A, within a range between the vehicle speeds V1 and V2, the speed change ratio TR of the continuously variable transmission is continuously changed within a range from the large speed change ratio TR2 to the small speed change ratio TR2. In the meantime, as shown in FIG. 17B, the number of rotations Ne of the engine is maintained to the number of rotations Ne1.

As shown in FIG. 17A, when the vehicle speed exceeds the vehicle speed V2, the speed change ratio TR of the continuously variable transmission is maintained to the small speed change ratio TR2. In the meantime, as shown in FIG. 16B, the number of rotations Ne of the engine gradually increases from the number of rotations Ne1.

On the other hand, as shown in FIG. 1, the rotating electric machine 100 is connected to the engine 10. Therefore, as shown in FIG. 17C, the number of rotations Ng of the rotating electric machine 100 changes like the number of rotations Ne of the engine shown in FIG. 17B.

Further, since the axial distance ΔL of the second rotor 120B in the rotating electric machine 100 changes in interlocking relation with control of the speed change ratio TR shown in FIG. 17A, the axial distance ΔL changes as shown in FIG. 17D. Specifically, the axial distance ΔL is maintained to zero until the vehicle speed V1 is reached and, in a range between the vehicle speeds V1 and V2, increases up to ΔLmax with increasing vehicle speed V. Further, when the vehicle speed V2 is exceeded, the axial distance ΔL is maintained to ΔLmax.

As mentioned above, the relative phase difference of the second rotor 120B from the first rotor 120A is the reference angle (0 degree) when the axial distance ΔL is 0. The rotating electric machine is designed such that, when the axial distance ΔL is ΔLmax, the relative phase difference of the second rotor 120B from the first rotor 120A becomes a mechanical angle of 45 degrees (an electrical angle of 90 degrees).

Therefore, the relative phase difference of the second rotor 120B from the first rotor 120A changes with the number of rotations Ng of the rotating electric machine 100 in the same way as in FIG. 17D.

With the permanent magnet field type rotating electric machine 100 used as a generator, when the rotational angular velocity ω (number of rotations) of the rotating electric machine increases, the induced electromotive force of the rotating electric machine proportionally increases. In this case, with the rotating electric machine of the present embodiment, the position of the permanent magnets of the second rotor relative to the permanent magnets of the first rotor is changed to change the relative phase angle and accordingly reduce the amount of effective magnetic flux, thus enabling power generation at high rotational speed.

Assume a case where the control unit 40 controls the relative phase difference of the second rotor 120B from the first rotor 120A of the rotating electric machine 100 in interlocking relation with control of the speed change ratio of the continuously variable transmission 20, like the present embodiment. At the vehicle speed V1 or higher as shown in FIG. 17D, when the vehicle speed increases the relative phase difference can be increased allowing control so as to decrease the amount of effective magnetic flux, thus enabling power generation at high rotational speed. Therefore, the speed change ratio of the continuously variable transmission 20 and the amount of effective magnetic flux of the variable flux type rotating electric machine 100 can be controlled using a single control unit.

What is claimed is:

1. A hybrid vehicles comprising:
an engine;
a rotating electric machine operating as a motor or a generator; and
a continuously variable transmission connected to an output shaft of the engine;
wherein the rotating electric machine is the permanent magnet field type having field-generating permanent magnets on a rotor, and also the variable flux type having first and second rotors rotatably provided on the inner circumference of a stator so that the amount of effective magnetic flux can be varied through means for adjusting the relative phase angle by changing a magnetic pole position by permanent magnets of the second rotor relative to a magnetic pole position by permanent magnets of the first rotor;
the hybrid vehicle further comprising means for controlling the speed change ratio of the continuously variable transmission; and
interlocking means for changing the magnetic pole position of the second rotor in the variable flux type rotating electric machine in interlocking relation with variable control of the speed change ratio of the continuously variable transmission by the control means.

2. The hybrid vehicle according to claim 1,
wherein the actuator of the continuously variable transmission is a hydraulic transmission actuator controlled by the control means; and
wherein the interlocking means is a hydraulic actuator for phase angle adjustment driving the relative phase angle adjustment means of the rotating electric machine and being driven by the hydraulic pressure supplied to the hydraulic transmission actuator.

3. The hybrid vehicle according to claim 1,
wherein the actuator of the continuously variable transmission is a transmission actuator controlled by the control means; and
wherein the interlocking means is a link mechanism driving the relative phase angle adjustment means of the rotating electric machine and transmitting the variation of the center distance of a pulley of the continuously variable transmission driven by the transmission actuator.

4. The hybrid vehicle according to claim 1, wherein:
the rotating electric machine is connected to the output shaft side of the continuously variable transmission.

5. The hybrid vehicle according to claim 1, wherein:
the rotating electric machine is connected to the input shaft side of the continuously variable transmission.

6. The hybrid vehicle according to claim 1, wherein:
the relative phase angle adjustment means is composed of a differential mechanism.

7. The hybrid vehicle according to claim 1, wherein:
the relative phase angle adjustment means is configured such that the first rotor is fixed to a shaft, the second rotor is separated from the shaft, and the shaft and the second rotor can be displaced within an angular range for a single magnetic pole.
